(19) United States
(12) Patent Application Publication
(10) Pub. No.: US 2019/0026782 A1
(43) Pub. Date: Jan. 24, 2019

(54) COMPUTER SYSTEM OR METHOD FOR COORDINATING AND COLLABORATING REMOTE ONLINE IDENTITIES OF INFLUENCERS ON SOCIAL MEDIA NETWORKS

(71) Applicant: Visual Amplifiers Ltd, Sydney (AU)

(72) Inventors: Benjamin Francis McGrath, Clontarf (AU); Aaron William Alan Brooks, Waverley (AU)

(21) Appl. No.: 15/948,894

(22) Filed: Apr. 9, 2018

(30) Foreign Application Priority Data
Jul. 21, 2017 (AU) 2017902857

(51) Int. Cl. G06Q 30/02; G06F 17/30; G06Q 50/00; G06Q 30/06

(52) U.S. Cl. CPC G06Q 30/0269; G06F 17/30867; G06Q 30/0254; G06Q 50/01; G06Q 30/0641; G06Q 30/0242

(57) ABSTRACT

A social media contents proceeding method adapted to be executed on a computing device connected to the Internet, wherein the method comprises the steps of: providing a user interface on the computing device for receiving one or more criteria, which comprises one or more of age, gender, theme, number of followers, engagement rate, related to a social market media campaign with a predefined online handle; connecting to a database management system for compiling a set of online identities on social media websites matching one or more criteria; retrieving social media contents from one or more social media websites associated with the online handle and the online identities, and calculating a total amount of social media contents associated with each of the online identities with the online handle.

### PRIORITY CLAIM

This application claims the benefit of the filing date of Australian Provisional Patent Application Serial No. 2017902857, filed Jul. 21, 2017, for “A COMPUTER SYSTEM OR METHOD FOR COORDINATING AND COLLABORATING REMOTE ONLINE IDENTITIES OF INFLUENCERS ON SOCIAL MEDIA NETWORKS.”

### TECHNICAL FIELD

The invention relates to social media influencers and, in particular, the present invention relates to a computer system, software or method for recruiting and managing social media influencers in marketing campaigns or social media networks.

### BACKGROUND

In Australia, more than half of the population are active monthly users of social media and social media networks. The ever-increasing exposure of social networking activity supported by social networking entities, such as FACEBOOK® and TWITTER®, provides an open forum for sharing opinions and attitudes concerning a plethora of experiences and events. Many users frequently post their reviews and opinions of restaurants they dine at, products they purchase, professionals they engage and/or services they use. Other third-party people then read this information and then may re-post or share the information to others in their respective groups and communities, reply with their comments, and/or submit their reaction in some other manner, e.g., indicating they endorse or condemn the post or content.

Social networking information is identified to be an effective marketing tool to a brand owner. It may be used spread good and bad experiences of a particular brand to all walks of life without much scrutiny. In a sense, social media allows the users to provide customer survey and feedback that can define the brand image of the brand. For example, in 2009, after the song “United Breaks Guitar” shared by musician Dave Carroll went viral, United Airlines' stock price fluctuated and cost stockholders millions in value. In 2017, a viral video of a passenger dragged out of a United Airline passenger jet and a few comments of its CEO caused another huge fluctuation.

There were social media monitoring services that provided the function of scanning the volumes of contents published by social networking entities, and could collect content relating to particular subjects. Some services provided keyword search capabilities and could collect social media containing one or more keywords. Other services might be able to perform a semantic and/or a grammatical analysis of the collected content to filter out content that contains a keyword but was not related to a topic of interest.

While these sorts of information might be useful to the brand owner, it could also be difficult to manage and interpret. Currently, there is no integrated platform for any brand owners to select, engage and manage a set of social media influencers from a domain of online identities, or social media influencers assisting brand owners to advance their markets.

In this specification, an online identity can be a person, a company, or a group of people sharing a single identity on a social media network.

Previously, U.S. Pat. No. 9,262,722 disclosed a social networking application program for measuring the social networker's collective influence on the registered social networking websites. The program was adapted to automatically collect empirical data regarding the social networker's use and activity level for the social networking websites. This included measuring frequency of an activity posting by the social networker to the social networking websites within a predetermined period. The program then determined the number of responses to the activity posting and measured the length, quantitative and qualitative discussion emanating from the social networker's activity posting. The program further measured a third party's use of the social networker's activity posting and assigned individual weighted scores for each quantitative and qualitative empirical data. With these data, the program generated an impact score by tabulating an aggregate of the individual weighted scores derived from the plurality of weighted scores; and posted the impact score on a social networking website viewable by the social networker and a community of friends. This program provided a method of comparing influencers on the social media website. However, this specification does not disclose or teach that a marketer may be allowed to coordinate and collaborate with the identified influencers.

U.S. Patent Application Publication No. 2009/0063254 disclosed a computer software for identifying one or more influencers. The computer software involved executing the following steps: (a) obtaining a list of customers; (b) determining a social network for each of the customers; (c) selecting one or more attributes to be used for predicting a measure of influence for each of the customers; and (d) determining one or more influencers in the social network by using the one or more attributes. This computer software provided a method of identifying the influencers on a social media website. However, this software does not allow a marketer to coordinate and collaborate with the identified influencers.

U.S. Patent Application Publication No. 2004/0167814 disclosed a method regarding influence network marketing. The goal of this method is to provide a framework for marketing a product to a plurality of consumers in a target online community. This method comprises the steps of: (a) determining an influence network for the consumers in the target community; (b) identifying opinion leaders from among the members in the influence network; (c) presenting the product to the opinion leaders; and (d) assisting with dispersion of evaluations of the products from opinion leaders to the members in the target community by using the influence network. This prior art merely disclosed a theory of marketing through influencers. However, this method does not allow a marketer to coordinate and collaborate with the identified influencers.

U.S. Patent Application Publication No. 2012/0150631 disclosed a method in relation to key influencer-based social media marketing. This prior art document disclosed a method for engaging social network users that comprised the steps of: (a) determining characteristics of key influencers; (b) setting search parameters based upon the determined characteristics; (c) searching social media feeds for possible key influencers; and (d) targeting possible key influencers with comments. The method is adapted to search for relevant keywords across social networks, blogs, forums, and the like; filtering conversations that contain relevant keywords to show only conversations near a business location; and responding to location-based conversations, driving potential customers to a call-to-landing page, whereby one has a one-on-one conversation at or about a specific geographic location with people having a conversation relevant to a particular business. This prior art merely disclosed a theory of marketing through influencers. However, this method also does not allow a marketer to coordinate and collaborate with the identified influencers.

### BRIEF SUMMARY

### Problems to be Solved

The present invention relates to a computer system or method for coordinating and collaborating remote online identities on social media networks.

It is, therefore, an object of the present invention to provide a new and novel computer system and method that provides a platform for coordination and collaboration with social media network influencers.

Other objects and advantages will become apparent when taken into consideration with the following specification and drawings.

It is also an object of the present invention to overcome or ameliorate at least one of the disadvantages of the prior art, or to provide a useful alternative.

It is a first aspect of the present invention to provide a social media contents proceeding method adapted to be executed on a computing device connected to the Internet, wherein the method comprises the steps of:
providing a user interface on the computing device for receiving one or more criteria, which comprises one or more of age, gender, theme, number of followers, engagement rate, related to a social market media campaign with a predefined online handle;
connecting to a database management system for compiling a set of online identities on social media websites matching one or more criteria;
retrieving social media contents from one or more social media websites associated with the online handle and the online identities, and
calculating a total amount of social media contents associated with each of the online identities with the online handle.

Preferably, the step of compiling a set of online identities further comprises the steps of adding one or more online identities to the set.

Preferably, the step of compiling a set of online identities further comprises the steps of removing one or more online identities to the set.

Preferably, the method further comprises the steps of:
displaying one or more statistical presentations in accordance with the retrieved set of online identities;
receiving input from a user to adjust the statistical data on the statistical presentations; and
adding or removing one or more online identities such that the set of online identities satisfies the adjusted statistical data.

Preferably, the statistical data comprises a total budget for a project.

Preferably, the method further comprises the step of sending an electronic invitation in one data format to each of the online identities in the set.

Preferably, the method further comprises the steps of receiving a quote message sent from one or more online identities in the set.

Preferably, the method further comprises the steps of compiling a final set of online identities, and forwarding a commission message to each of the online identities in the final set.

Preferably, the method further comprises the steps of:
compiling a tracking report in accordance with the retrieved social media contents,
wherein the tracking report comprises a list of each online identity and corresponding status in the marketing campaign.

Preferably, the tracking report comprises aggregate data comprising one or more of engagement rate, bounce rate, traffic driven, number of shares, track conversation rate, amplification, applause rate, or leads, in accordance with the retrieved social media contents.

Preferably, the method further comprises the steps of:
accepting one or more orders from a user device of an online identity;
updating the status of the online identities.

Preferably, the method further comprises the steps of determining a payment threshold status in accordance with the total amount of social media contents of an online identity.

Preferably, the method further comprises the step of making an electronic payment to the online identity based on the payment threshold status through a transaction server.

Preferably, the method further comprises the steps of automatically distributing, linking, or sharing one or more retrieved social media contents on a webpage.

The second aspect of the present invention provides a computer system, having a processing unit, data storage, and a communication module for connecting to the Internet, comprising:
a user interface adapted to receive one or more criteria, including one or more of age, gender, theme, number of follows, engagement rate, and related to a social market media campaign with a predefined online handle to the computer server;
a database management system for compiling a set of online identities on social media websites matching one or more criteria;
a data retriever adapted to retrieving social media contents from one or more social media websites associated with the online handle and the online identities,
such that the processing unit is adapted to calculate a total amount of social media contents associated with each of the online identities with the online handle.

Preferably, the processing unit is adapted to determine payment threshold status in accordance with the total amount of social media contents of an online identity, and forward electronic payment instructions to a transaction server for transferring payment to the online identity.

Preferably, the processing unit automatically distributes, links, or shares one or more retrieved social media contents on a remote web server.

Preferably, the computer system further comprises:
a statistical data display interface adapted to receive input from a user to adjust the statistical data on the statistical presentation in accordance with the retrieved set of online identities;
such that the statistical display interface is adapted to allow the adding or removing of one or more online identities such that the set of online identities satisfies the adjusted statistical data.

Preferably, the communication module is adapted to sending an electronic invitation in one data format to each of the online identities in the set, receiving a quote message or an order from an online identity.

Preferably, the electronic device comprising:
a message editor for an online identity to compile a quote message in response to the invitation; and
an ordering interface for an online identity to select an item to order.

### BRIEF DESCRIPTION OF THE FIGURES

The patent or application file contains at least one drawing in color. Copies of this patent or patent application publication with color drawings will be provided by the Office upon request and payment of necessary fees.

FIG. 1 is a schematic diagram of an electronic system of an embodiment of the present invention;

FIG. 2 is a schematic diagram of a system or method of an embodiment of the present invention;

FIG. 3 is a flowchart showing a login process of an embodiment of the present invention;

FIG. 4 is a flowchart showing a registration process of an embodiment of the present invention;

FIG. 5 is a flowchart showing a request of password process of an embodiment of the present invention;

FIG. 6 is a flowchart showing a process to create a marketing campaign on the system of an embodiment of the present invention;

FIG. 7 is a flowchart of managing a market campaign on the system of an embodiment of the present invention;

FIG. 8 is a screenshot of an interface of an embodiment of the present invention;

FIG. 9 is a screenshot of an interface for account set up of an embodiment of the present invention;

FIG. 10 is a screenshot of an interface for customizing an account of an embodiment of the present invention;

FIG. 11 is a further screen shot of an interface for customizing an account of an embodiment of the present invention;

FIG. 12 is a screenshot of an interface for logging into an account of an embodiment of the present invention;

FIG. 13 is a screenshot of an interface for a campaign overview of an embodiment of the present invention;

FIG. 14 is a screenshot of an interface for creating a marketing campaign identity of an embodiment of the present invention;

FIG. 15 is a screenshot of an interface for creating marketing campaign details of an embodiment of the present invention;

FIG. 16 is another screenshot of an interface for creating marketing campaign details of an embodiment of the present invention;

FIG. 17 is a screenshot of an interface for previewing a marketing campaign of an embodiment of the present invention;

FIG. 18 is a screenshot of an interface for inviting influencers of an embodiment of the present invention;

FIG. 19 is a screenshot of an interface for manually inviting influencers of an embodiment of the present invention;

FIG. 20 is a screenshot of an interface for filtering influencers of an embodiment of the present invention;

FIG. 21 is a screenshot of an interface for distribution payment of an embodiment of the present invention;

FIG. 22 is a screenshot of an interface for an SMS invite of an embodiment of the present invention;

FIG. 23 is a screenshot of an interface for an email invite of an embodiment of the present invention;

FIG. 24 is a screenshot of an interface for overviewing and selecting influencers of an embodiment of the present invention;

FIG. 25 is a screenshot of an interface for approving and rejecting influencers of an embodiment of the present invention;

FIG. 26 is a screenshot of an interface for an invite filter of an embodiment of the present invention;

FIG. 27 is a screenshot of an interface for managing influencers of an embodiment of the present invention;

FIG. 28 is a screenshot of an interface for managing chat messages of an embodiment of the present invention;

FIG. 29 is a further screenshot of an interface for managing chat messages of an embodiment of the present invention;

FIG. 30 is a screenshot of an interface for reporting invite influencers of an embodiment of the present invention;

FIG. 31 is a screenshot of an interface for reporting an invite influencer of an embodiment of the present invention;

FIG. 32 is a screenshot of an interface for reporting a marketing campaign of an embodiment of the present invention;

FIG. 33 is a screenshot of an interface for dynamic creative content of an embodiment of the present invention;

FIG. 34 is a screenshot of an interface for a format output of an embodiment of the present invention;

FIG. 35 is a further screenshot of an interface for a format output of an embodiment of the present invention;

FIG. 36 is a further screenshot of an interface for a format output of an embodiment of the present invention;

FIG. 37 is a screenshot of contact details of an embodiment of the present invention;

FIG. 38 is a screenshot of demographic information of an influencer of an embodiment of the present invention;

FIG. 39 is a screenshot of an interface for specialties information of an influencer of an embodiment of the present invention;

FIG. 40 is a screenshot of an interface for a SMS invited to an influencer of an embodiment of the present invention;

FIG. 41 is a screenshot of an interface for an email invited to an influencer of an embodiment of the present invention;

FIG. 42 is a screenshot of an interface for a brief overview of an embodiment of the present invention;

FIG. 43 is a further screenshot of an interface for a brief overview of an embodiment of the present invention;

FIG. 44 is yet a further screenshot of an interface for a brief overview of an embodiment of the present invention;

FIG. 45 is a screenshot of an interface for chatting with brief supplier through a smart device app of an embodiment of the present invention;

FIG. 46 is a screenshot of an interface for invoicing the brief supplier from a smart device of an embodiment of the present invention; and

FIG. 47 is a screenshot of an interface for a post of the social media network of an embodiment of the present invention.

### DETAILED DESCRIPTION

Social media employed mobile and web-based technologies to create highly interactive platforms via which individuals and communities shared, co-created, discussed, and modified user-generated contents. Certain online identities, through activities on their blogs, tweets, viral channels, and the use of other social media, generated great interest toward their presences and formed a community around them. The individuals in the community tended to follow these identities and became influenced by the information posted by them. These online identities, or known as social media influencers (“influencer”), represented a new type of independent third-party endorsers who shaped or shapes audience attitudes via social media channel.

In many cases, an online identity was merely an alias or handle of a person, a company, a group or entity). It was not uncommon for a person to have two or more different online identities or handles.

As these influencers usually possessed the power to affect purchase decisions of others because of their real or perceived authority, knowledge, position, or relationship, vendors started to harness the influential power of these social media influencers (“SMI”) to promote their products in order to penetrate a target market in a more efficient and effective manner.

In an influencer marketing campaign, a vendor or brief supplier might provide a product to the influencers with or without cost, and expected the influencers to create social media contents through their personal social channels. Subsequently, the social media contents related to the product of the supplier could spread to consumers who shared similar interest as the influencers in order to generate a higher conversion rate.

Different influencers may have different interests or specialties. They also represented different demographics—age group, gender, ethnicity, personal preference, education, social status, . . . etc. Previously, marketing professionals were required to spend extensive resources and time to identify a right channel and the right influencers for their products in a successful social media marketing campaign. Further, a vendor or its marketing representative usually was able to identify one channel and engaged one influencer at a time. This previous method is extremely inefficient and ineffective.

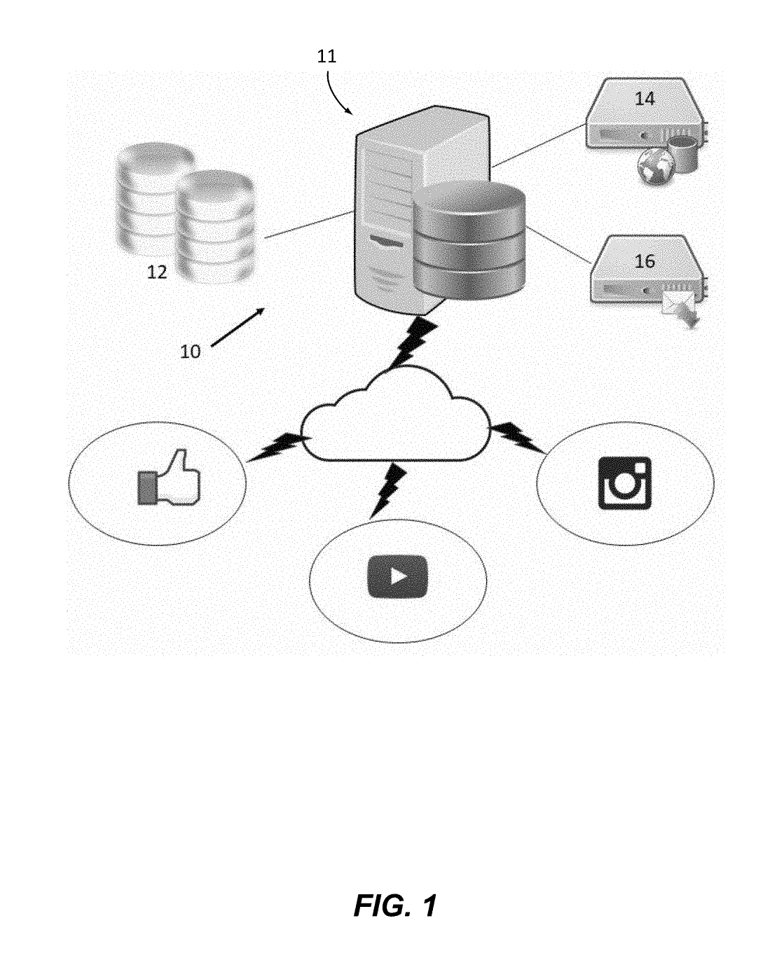

The present invention therefore provides a system 10 of an integrated platform for coordinating and collaborating with the influencers in a marketing campaign, which comprises a software to run on a computer system, as shown in FIG. 1, for coordinating and collaborating with social media influencers in a marketing campaign.

In one preferred embodiment of the present invention, there is provided a social media contents proceeding method to be executed on a computing device or system connected to Internet. The system provides a user interface on the computing device for receiving one or more criteria, which comprises one or more of age, gender, theme, number of follows, engagement rate, and is related to a social market media campaign with a predefined online handle. With this information, the system connects to a database management system for compiling a set of online identities on social media websites matching one or more criteria. The system then retrieves social media contents from one or more social media websites associated with the online handle and the online identities, and calculates a total amount of social media contents associated with each of the online identities with the online handle. The system of the present invention may facilitate marketing campaign creators to engage a team of unknown online identities or influencers to participate in a marketing campaign. The system provides an integrated platform to select and filters a large group of known or unknown online identities or influencers, automatically tracking social media contents posted by this group of online identities or influencers, calculating and making remunerations or rewards based on the automatically tracked records, and re-using and redistributing these social media contents over the Internet.

The system 10 comprises a computer server 11 associated with one or more database management system (DBMS) managing databases 12 for storing information of a group of social media influencers. The system 10 also is associated with one or more hyper-text transmission protocol servers 14 for receiving requests and forwarding hyper-text transmission protocol responses to the user. In one embodiment, the requests and responses are exchanged in other types of formats such as extended message language format, or embedded in JAVASCRIPT® object notation files. The system 10 further associates with a message exchange server 16 to receive and forward messages to the users.

In one embodiment of the present invention, there is provided a system 10 that provides a single end-to-end electronic computing platform for recruiting, product distribution and making a payment through the tracking of online performance scores or payment threshold status based on the product penetration on the Internet. In one embodiment, the system 10 will keep track of all the social media contents posted by an online identity or influencer, and release a payment based on the payment threshold status of the online identity or influencer. For example, the system 10 may recruit INSTAGRAM® talent to produce high quality custom content designed to increase exposure and reach of the brand through mass aggregation of talent audiences.

The present invention relates to a system 10 of an integrated platform for coordinating and collaborating with the influencers in a marketing campaign that is built around technology of searching and filtering the right influencers for each individual influencer marketing campaign.

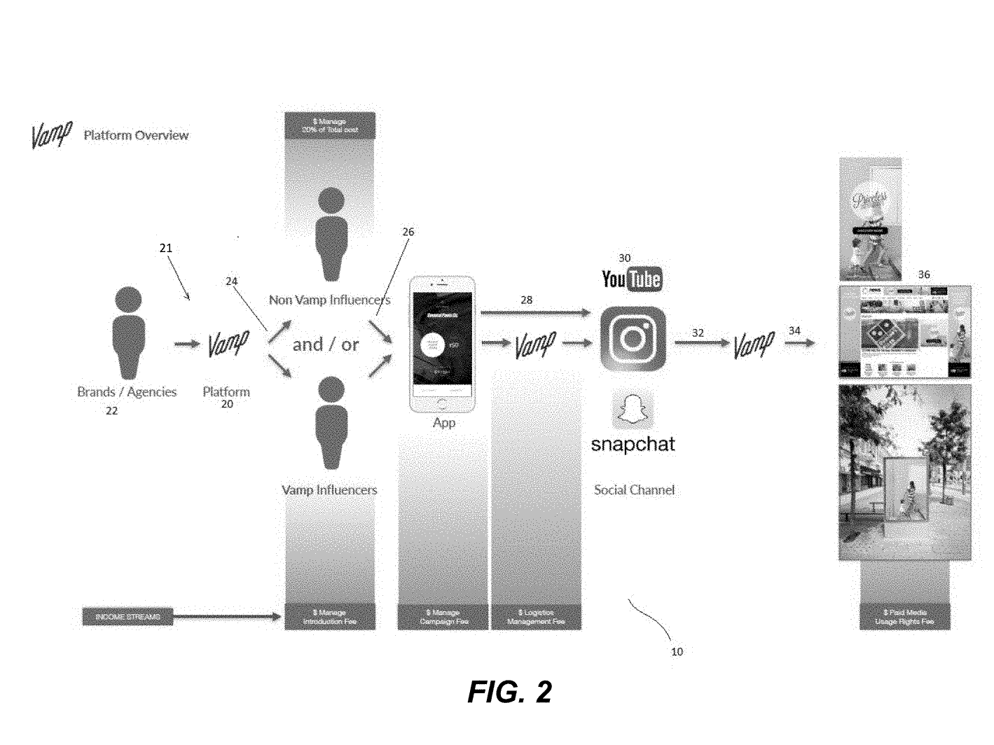

In one example as shown in FIG. 2, the system 10 is adapted to carry out a method 21 of an embodiment of the present invention. The system 10 or Vamp platform 20 allows a brand owner or agency 22 to login and manage a marketing campaign. Through the system 10 or Vamp platform 20, the brand owner or agency 22 may select a list of online identities from the group of register online identities, and unregistered online identities as shown in step 24. The registered online identities are influencers who have opened an account on the system 10 or Vamp platform 20. The unregistered online identities are anyone who has not opened an account on the system 10 or Vamp platform 20.

The system 10 or Vamp platform 20 then manages the campaign, sends out emails and messages to the list of online identities as shown in step 26.

In the method 21, the brand owner or marketing agency 22 accesses system 10 through logging into the system 10 or Vamp platform 20. The brand owner or marketing agency 22 then initiates a campaign by creating a campaign project profile on system 10 or Vamp platform 20.

The system 10 or the Vamp platform 20 is adapted to provide the facility to define the marketing tasks for the online identities or influencers. For example, the brand owner or agency 22 would like to promote its new product, and would send out the product for the online identities or influencers to review, and promote. The brand owner may use the facility provide by the system 10 or the Vamp platform 20 to create an invite and a briefing package. When an online identity or influencer accepts the invitation, the system 10 or the Vamp platform 20 will notify the brand owner or agency 22 to send out the briefing package.

After that, the brand owner or agency 22 may create the campaign by setting up the background material for the campaign such as inputting the name, description, target audience characteristics, etc. In step 24, based on the background information, the system 10 or Vamp platform 20 connects to the database 12 through the DBMS of the server 11 to retrieve a list of online identities or influencers, and allows the brand owner or agency 22 to select a list of online identities from the group online identities. The brand owner or agency 22 may search and filter a set of online identities retrieved from the databases 12 and store it in the campaign project profile. In another embodiment, the brand owner or agency 22 may provide a set of online identities, which are not stored in the databases 12.

Once the brand owner or agency 22 settles with a list of online identities, the system 10 or Vamp platform 20 will provide the function to manage the campaign, and send out emails and messages to the list of online identities as shown in step 26. The system 10 may further include a function for the online identities or influencers to accept or reject an invitation.

After the online identities accepts the task, the system 10 or Vamp platform 20 will notify the brand owner or agency 22 through the management subsystem 28. Through management subsystem 28, the brand owner or agency 22 may review the list of online identities or influencers who have accepted the task. In one embodiment, the management subsystem 28 is installed with the facility to track the progress of each online identity or influencer. For example, the management subsystem 28 is adapted to record whether the briefing package is sent and delivered.

When the online identity or influencer receives the briefing package, he or she should follow the directions given with the briefing package. Typically, the online identities or influencers will try the product or use a particular service. The online identities and the influencers will base on their experience post comments, create blogs, images, etc., and share them on social media website 30 such as YouTube®, INSTAGRAM®, PINTEREST®, TUMBLR®, SNAPSHOT®, REDDIT®, FLICKR®, . . . etc.

In one embodiment, the system 10 or Vamp platform 20 comprises a tracking interface 32. The tracking interface is adapted to track or follow the online identities posts on social media websites. By tracking and following the online identities posts on social media websites, the system 10 or Vamp platform 20 collects data of the progress of the campaign, and the performance of the online influencer. The data will be stored in a database 12 of the system 10 for further analysis.

In one embodiment, the tracking interface 32 is in a form of a number of application programming interfaces for crawling a list of predefined social media websites. In one embodiment, tracking interface 32 connects to and communicates with the application programming interface with the social media websites to collect data on the social media website (data scrapping). The tracking interface 32 is adapted to track the post contents, number of shares, number of endorsements, and number of viewers of a post by an influencer. In another embodiment, the tracking interface 32 collects the raw data online to generate metrics such as the conversation rate, amplification rate, applause rate, and leads to business.

The system 10 or Vamp platform 20 also provides the facilities for generating and viewing reports of a campaign as in step 34. The reporting facilities allow the brand owner or agency 22 to track the overall progress of the campaign. The reporting facilities also allow the brand owner or agency 22 to track the progress of each individual influencer. In one embodiment, the reporting facilities may be associated with a payment approval interface, so that the brand owner or agency 22 may send instructions to the payment institutes through the payment approval interface for distribution of payment to the online identities or influencers. In one embodiment, the brand owner or agency 22 may review the report of the campaign and the progress of the online identities or influencers. When an online identity or influencer achieves its goal or key performance indicator, the brand owner or agency 22 may use the interface provided by the system 10 or Vamp platform 20 to approve a distribution of payment.

In one embodiment, the interface for approving the distribution of payment is an action button for the brand owner or agency 22 to click on. In another embodiment, the interface is an automated system, and automatically approves the distribution once the goal is achieved or PKI is fulfilled. In an embodiment, the interface is linked to a banking facility for directing the banking facility to deposit the promised amount to the online identities or influencers. In another embodiment, the system 10 or Vamp platform 20 allows the online identity or influencer to log into the system and review its performance report.

In one embodiment, the system 10 or Vamp platform 20 provides an interface to compile, update and manage an online presence as shown in step 36 using the posts or feeds provided by the online identities.

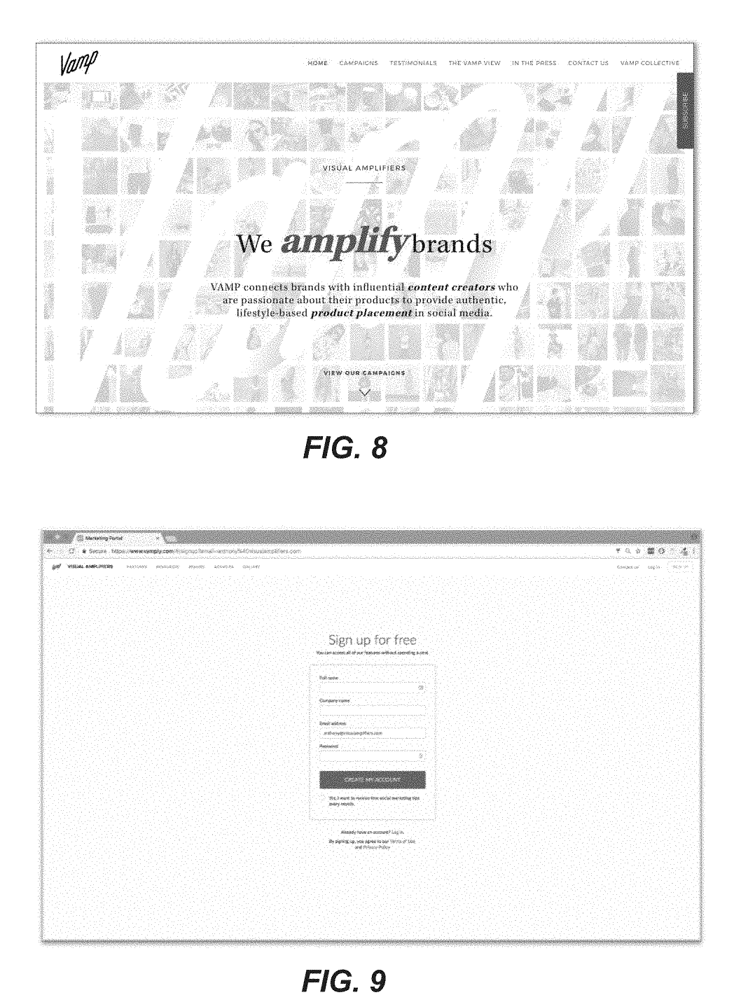

FIG. 8 shows the front page of an interface displayed on one of the embodiment of the present invention. When the program or application of an embodiment of the present invention is loaded up, it will present an interface of FIG. 8 or other similar interfaces.

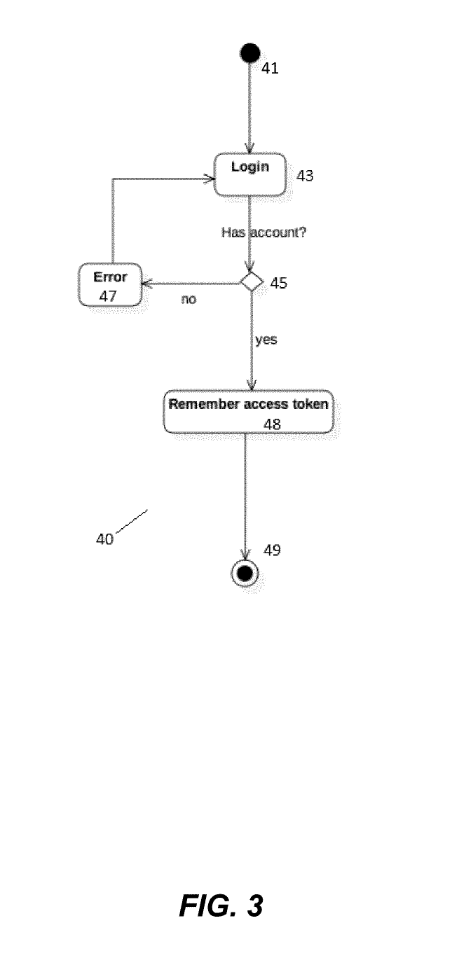

Referring to FIG. 3, there is provided a flowchart for a login process 40 of an embodiment of the present invention. The login process 40 begins in Step 41. In Step 43, the system 10 or Vamp platform 20 provides an interface for a user to login. In one embodiment, a user can be an administrator, a brand owner/campaign creator, or an online identity/influencer. There is no need for a user to specify which type of account he or she is logging in. The system 10 or Vamp platform 20 is adapted to load the correct profile and credential when the user is logged into the system. In one embodiment, on the login interface provide in Step 43, the user is required to provide a user name and a password in order to login. In Step 45, the system 10 or Vamp platform 20 checks whether the login information is correct. In the event that the information is not correct, an error message will be displayed as shown in Step 47. In the event that the login information is correct, an access token is created and stored in the system 10 or Vamp platform 20 in Step 48. In Step 49, the login process is concluded, and the user profile and credential are loaded to the system. In another embodiment, the user may login using Open Authorization (OAuth) that allows a user's account information to be used by third-party services, such as FACEBOOK®, without exposing the user's password.

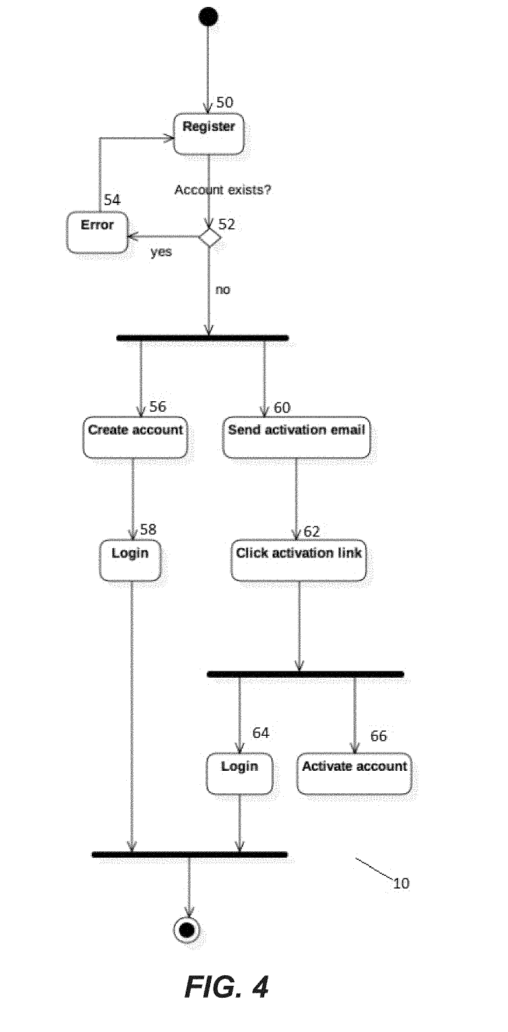

Referring to FIG. 4 is a flowchart showing a registration process using the interface shown in FIG. 9. The interface allows a user to enter the user information such as the full name, company name, email address and password. In one embodiment, the password can be automatically generated by the system 10.

Referring to FIG. 4, the registration process 50 begins and the registration interface as shown in FIG. 9 is displayed. The user enters the user information and sends the information to the system 10 by clicking the icon entitled “CREATE MY ACCOUNT.” When the system 10 receives the use information, it will check whether the account exists in the system as shown in Step 52. In this subroutine, the system 10 will connect to the user database and cross reference against the full name and company of the user. The system will display an error message if it finds out that an account already exists as shown in Step 54.

In the event that the system 10 cannot find an existing account that matches with the user, the system will then fork out two child processes. In one child process, the system will create an account as shown in Step 56. In this step 56, the system 10 will create a new record and user profile for the user in the database. The system 10 will then redirect the display to the login interface as shown in Step 58, but the user still cannot login with his or her own user name and password until the account has been activated.

In the other child process, system 10 will generate and send an activation email to the email address entered by the user as in Step 60 of FIG. 4 on the registration interface as shown in FIG. 9. In the activation email, there is provided an activation link on which the user may click in order to activate the account.

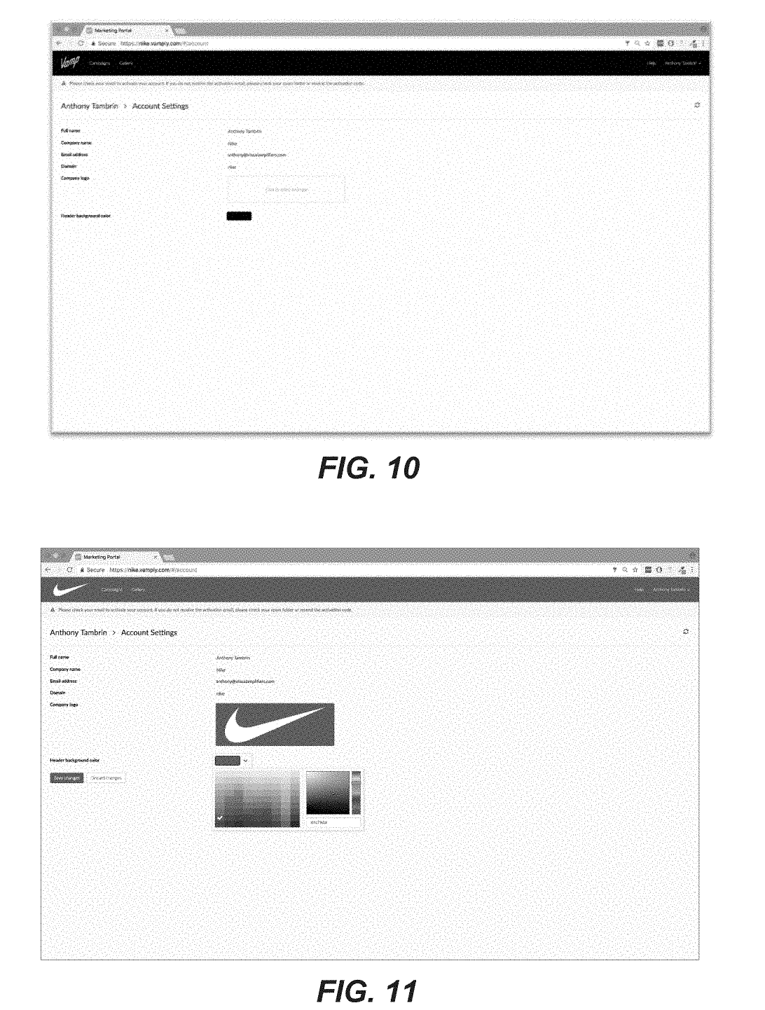

When the user receives and clicks on the activation link as shown in step 62, the system will redirect the user to the login interface as shown in Step 64. The system 10 will also activate the account of the user as shown in Step 66. The system 10 will internally update the status of the user from “pending” to “activated.” Once the user account is activated, the user may then enter further information as shown in FIGS. 10 and 11.

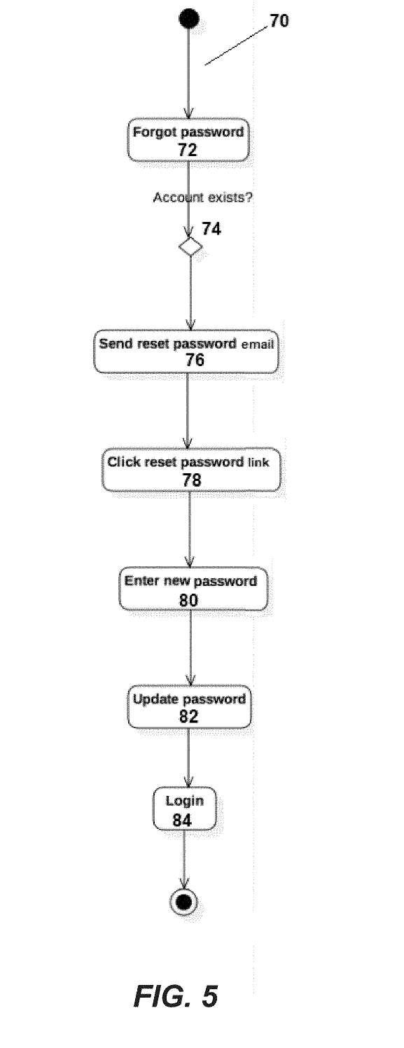

FIG. 5 shows a process for handling a lost or forgotten password. On the login interface (not shown), under the input text box for entering the password, typically there is provided a link for directing a user to activate a process to recover a lost password. When the user clicks on the link, the system will initiate the process for handling the lost password as shown in Step 70 of FIG. 5.

When a user clicks on a link for recovering a lost password, the system 10 (FIG. 1) will request some basic information from the user as shown in Step 72, such as User ID, login name, user name and date of birth, . . . etc. The system 10 then checks whether the user already has an account as shown in Step 74. If there is no match to a user in system 10, an error message will be displayed. If there is a match in the user database, the system 10 will retrieve the record of the user including the user email address. The system 10 then sends a Reset Password email to the user based on the retrieved email address to the user as shown in Step 76.

In the Reset Password email, there is embedded a link to reset the password of the user. When a user clicks on that link as shown in Step 78, the system 10 will direct the user to a Password Reset interface where the user can enter the new password as shown in Step 78. In one preferred embodiment of the Password Reset interface, the system 10 is adapted to provide real-time checking to verify the strength of the password, such as with minimum 8 characters, not a dictionary word, no consecutive numbers, must have at least one upper case, lower case and special character.

After the user enters a new password as shown in Step 80, the system 10 will update the new password and store it in the database as shown in Step 82. The system 10 then directs the user to the login interface as shown in Step 84 so that the user may now login to his or her account with the new password.

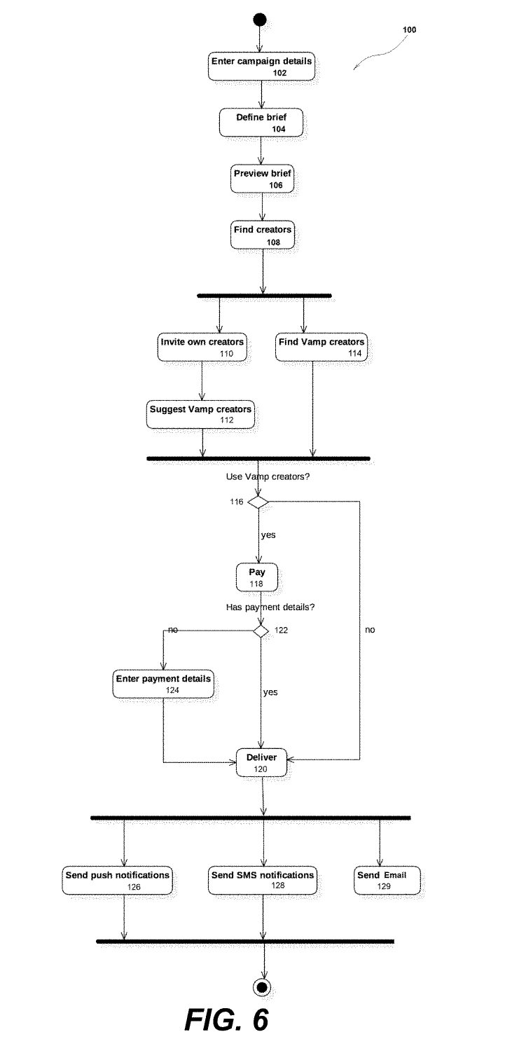

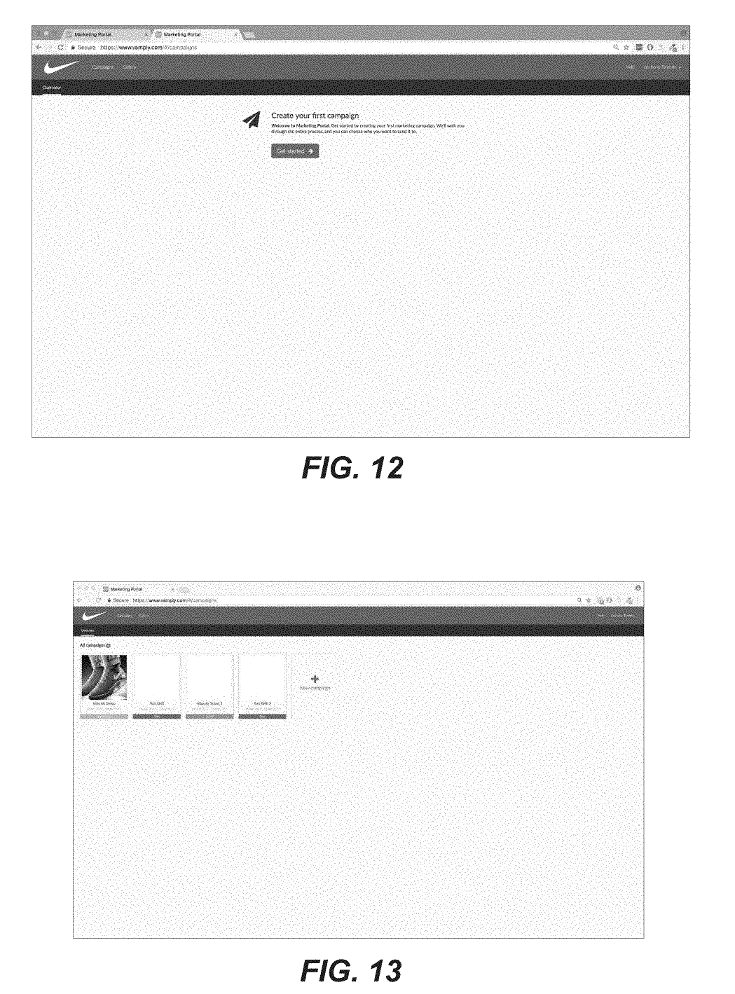

Reference is now made to FIG. 6 where a process 100 for creating a marketing campaign is shown. In one preferred embodiment, the process 100 started when a user clicks on a “Get started” icon in a campaign interface as shown in FIG. 12. The system 10 then directs a user to the campaign overview interface as shown in FIG. 13, where the system displays all the marketing campaign profiles.

In a further embodiment, the campaign overview interface lists all the campaign profiles along with images for identifying the campaign, a brief name of the campaign, the active dates of the campaign, and the status of the campaign. There is provided an icon or button for a user to create a new campaign. In one embodiment, the “create new campaign” icon or button is listed in front of all existing campaign profile. In another embodiment, the “create new campaign” icon or button is listed at the end of all existing campaign. In one embodiment, system 10 provides facilities for a user to filter, search and sort the campaign profiles.

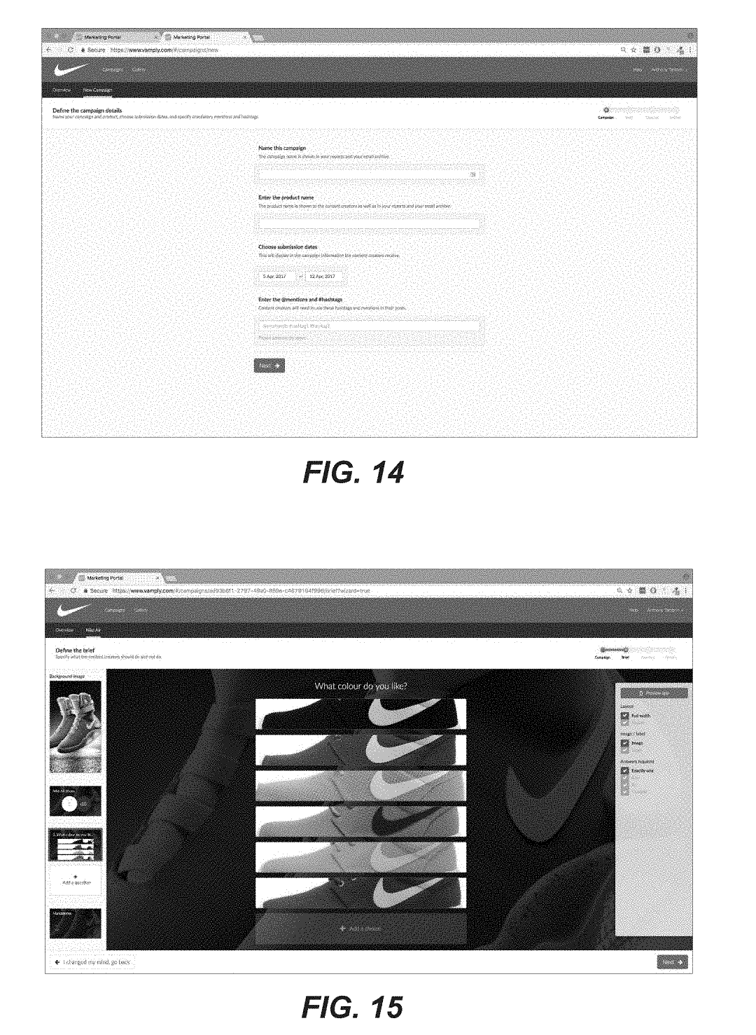

If the user clicks on the “create new campaign icon” or button, the system 10 will direct the user to the campaign input interface as shown in FIG. 14 for carrying out Step 102 of the process 100 for entering the campaign details. As shown in FIG. 14, the campaign input interface allows the user to provide the name of the campaign, the name of the product, the submission date, and the social media meta tag or handle such as @mentions or #hashtags.

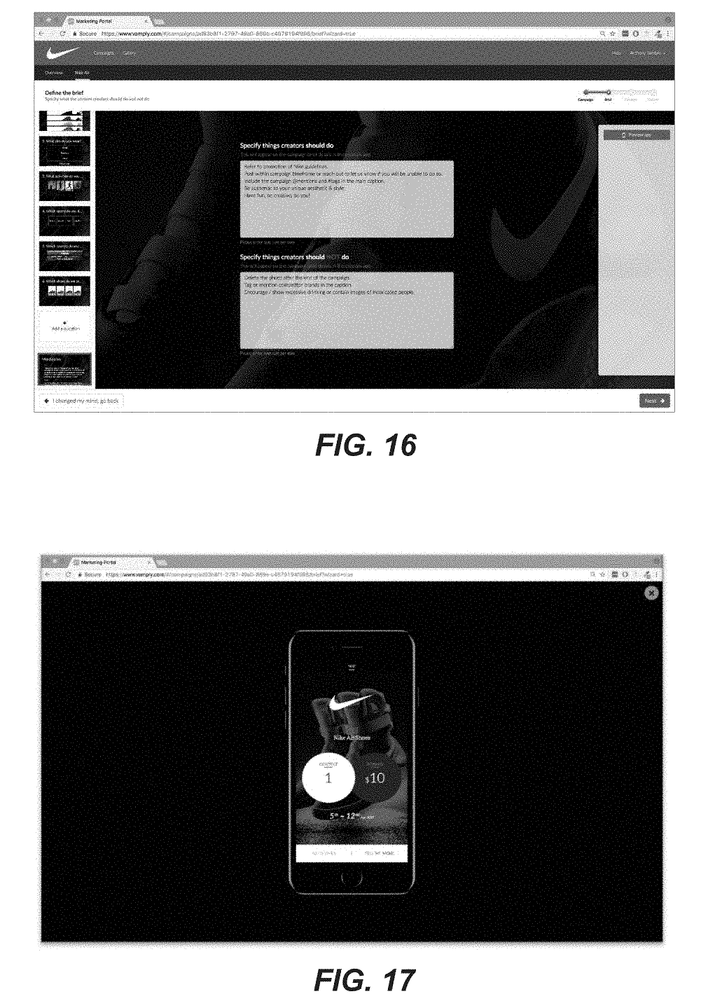

After the campaign details are entered into the system 10, it will direct the user to Brief Definition interface for carrying out Step 104 of the process 100 for defining a campaign brief which includes a set of instructions for the online identities or influencers to follow. An example of the Brief Definition interface is shown in FIGS. 15 to 17. The campaign brief specifies what the online identities or influencers should do or should not do during the campaign. Once the user has defined a campaign brief, the user may preview the campaign brief in Step 106.

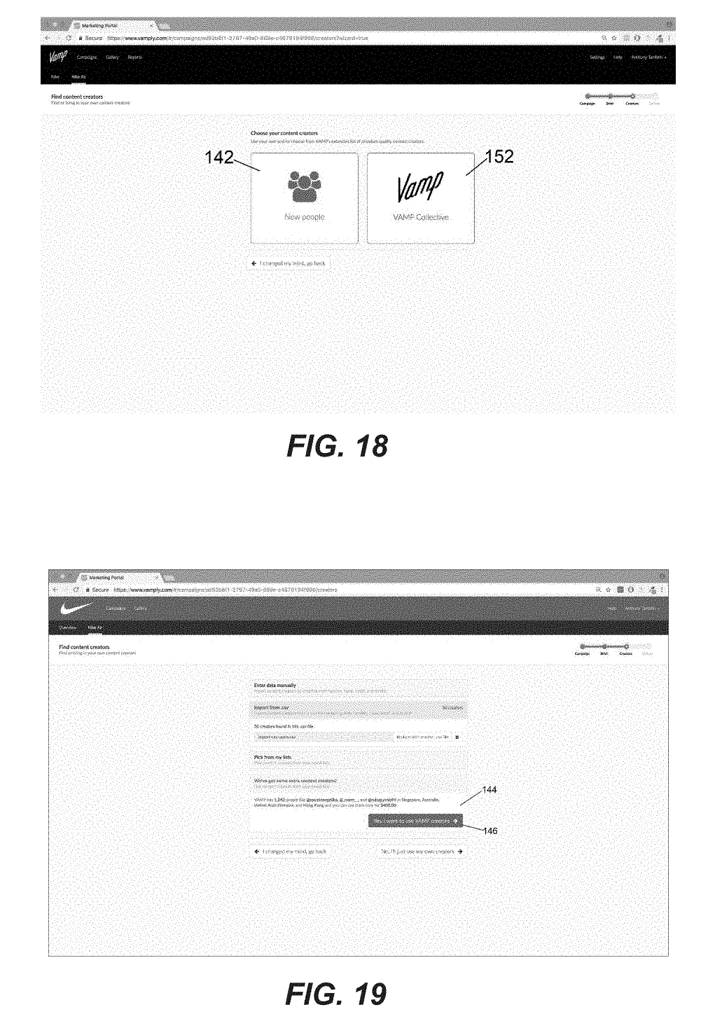

After the user has defined the campaign brief as in Step 104 and previewed the campaign brief as in Step 106, the system 10 then directs the user to the Find Content Creator interface as shown in FIG. 18. The system 10 provides an option icon 142 for the user to import the list of online identities to the system 10, or option icon 152 for the user to choose from a list of online identities stored in the system 10. Preferably, each entry from the list of online identities stored in the system 10 refers to an online identity who has been rated based on past records of participating in previous social media campaigns. The record of each entry may contain information such as location, gender, age group, theme, narrative, format, style, relationship, social channels, . . . etc.

When a user selects an option icon 142 for importing a list of online identities, the system 10 will direct the user to the Manual Data Entry interface as shown in FIG. 19 to carry out Step 110 for inviting the user's own online identities. In one embodiment, the system 10 is adapted to receiving a comma-separated values (csv) formatted file containing the online identities handles, name, email, and mobile number. The system 10 is adapted to parse the csv file and generate a list of online identities. In another embodiment, the system 10 is adapted to allow the user to pick the online identities from the user previous list of online identities.

When the user is importing the list of online identities or creating a new list using previous lists of online identities, the system 10 is adapted to carry out Step 112 for suggesting the online identities stored in the system database. In Step 112, the system 10 analyzes the list on the background to determine the common characteristics of the online identities selected by the user. The system 10 will determine a few online identities from the user selection list as model representatives of the online identities. The system 10 in real-time searches through the database for online identities who share similar characteristics of the model representatives. The system 10 then displays a message 144 as shown in FIG. 19 to the user indicating that it can provide an extra number of the online identities for a cost, and provides a link or button 146 (as shown in FIG. 19) for the user to commit to engage those online identities. A user may decide not to engage the online identities provided by the system 10 and proceed to the next step for checking if any of the online identities retrieved from the system database is used in Step 116.

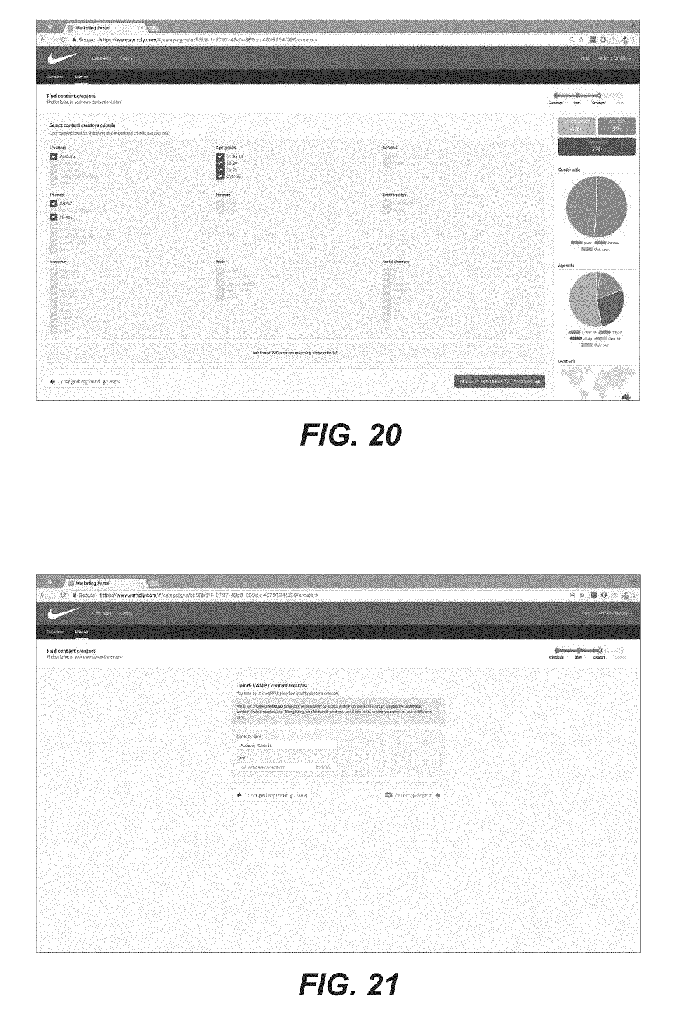

If the user chooses option icon 152 or decides to engage the online identities suggested by the system 10 by clicking on the link or button 146, the system 10 will then direct the user to the Find Content Creators interface to carry out Step 114 of finding a list of online identities as shown in FIG. 20. The Find Content Creators interface is adapted to allow the user to dynamically select online identities who possess certain characteristics, including: location, gender, age group, theme, narrative, format, style, relationship, social channels, . . . etc. The system 10 can generate demographic reports on-the-fly to show the demographic ratio of the selected online identities. In another embodiment, the system 10 allows the user to set the demographic ratio and search for a list of online identities for the closest fit to that demographic ratio. In one embodiment of this process, the user may first define the sample size and the demographic ratio as the input parameters. The system 10 will retrieve a list of people that will fit one or more characteristics of the model representatives according to the sample size. The system 10 will then replace one or more online representative on the list in order to fit closer to the demographic ratio.

In a further preferred embodiment, the Find Content Creators interface provides a link or button for the user to review individual online identity depending on the credential of the user. The credential of the user is given by the system 10 depending on a number of factors, such as the subscription level of the user. By reviewing, adding and removing individual online identities from the list, the user may fine tune the demographic ratio to suit the marketing campaign.

In one embodiment, after a user decides to engage the online identities provided by the system 10, the user proceeds to the next step for checking the amount of the online identities retrieved from the system database as in Step 116.

In the event that the user decides not to engage any online identities provided by the system 10, satisfies a no payment or discount threshold, the system 10 will proceed to Step 120 to deliver the invitations to the list of online identities.

In the event the user engages online identities provided by system 10, it will calculate the cost and direct the user to Payment interface as shown in FIG. 21 to carry out Step 118 which allows a user to enter payment information, such as the name on a credit or debit card, the card number and expiry date.

After the user enters the payment information, system 10 will proceed to Step 122 to check the validity of the payment details. In the event that the payment details are incorrect, the system 10 will prompt the user to enter the payment details again as in Step 124. In the event that the payment details are correct and the payment is clear, the system 10 will proceed to the next Step 120 to deliver the invitations to the list of online identities.

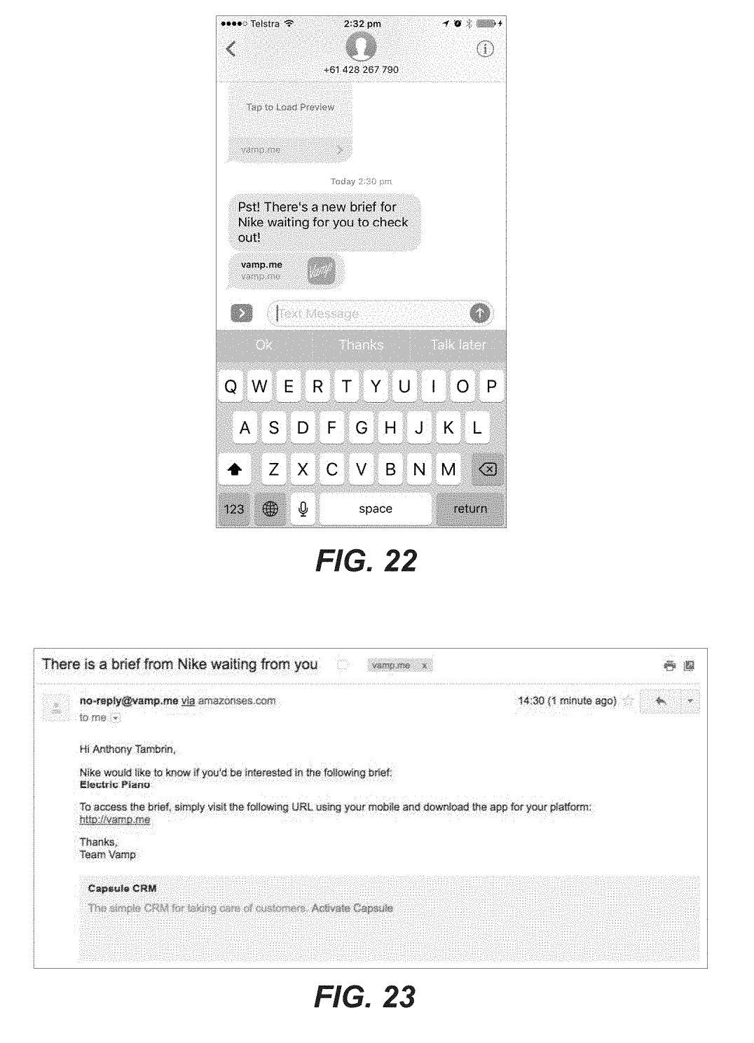

Once the system 10 receives the signal to deliver the invitations, the system will send out the invitations to the list of online identities through: (i) system notification for other users of the system in Step 126, (ii) Short Message Service (SMS) of mobile devices in Step 128, and (iii) Email in Step 129. FIG. 22 shows an invitation sent through SMS in Step 128; and FIG. 23 shows an invitation sent through email in Step 129.

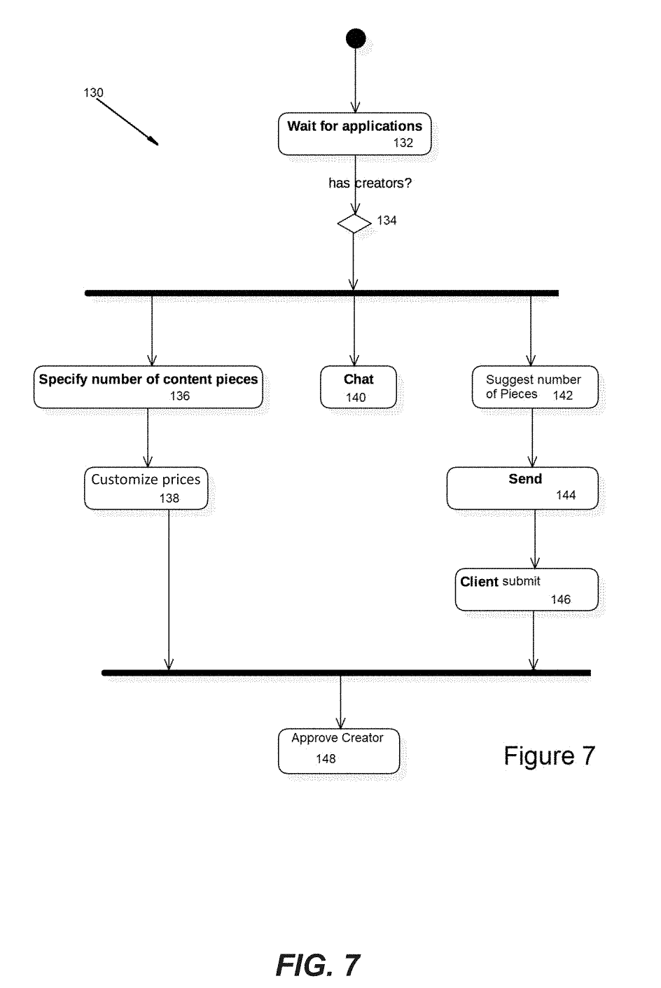

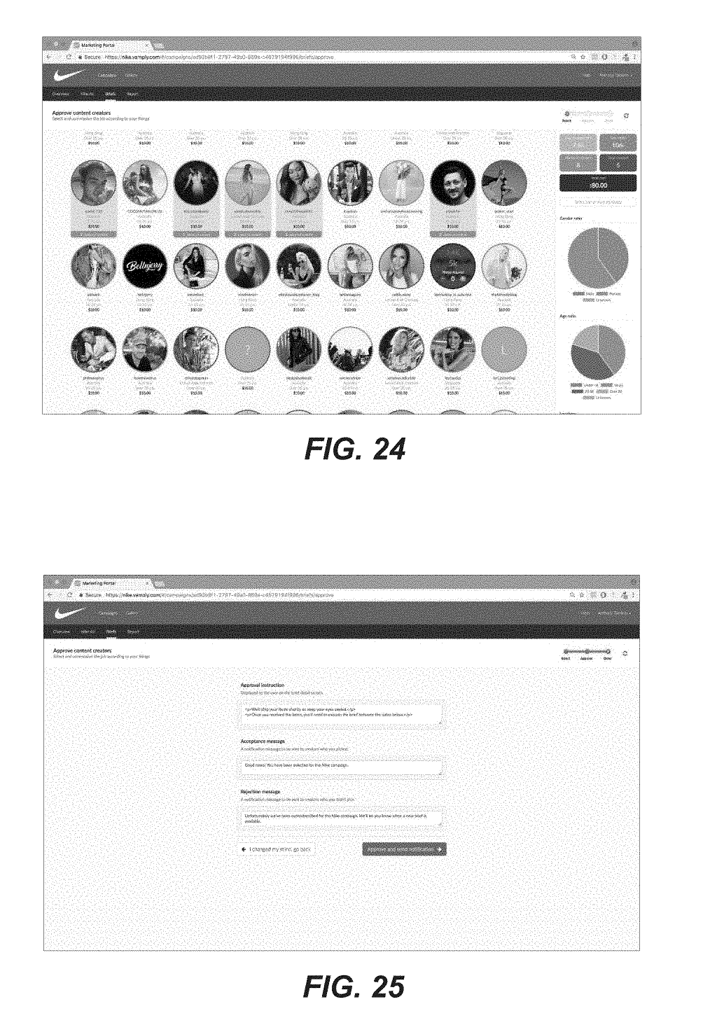

After the invitations are sent to the list of online identities, the system 10 will get ready to collect responses or applications from the online identities as shown in the process 130 of FIG. 7. The system 10 allows a campaign creator to wait for applications in Step 132. When an application arrived, the system 10 provides the function to check if the online identity and/or campaign creator is available in Step 134. Then the system 10 provides a platform for the online identities to communicate with the campaign creator. In one embodiment as shown in FIG. 24, the system 10 is adapted to allow the online identities to specify the number of content pieces in Step 136, and customize the price in Step 138. The system 10 also allows an online identity to carry out real-time voice, video or multimedia communication with the campaign creator through the system in Step 140. In another embodiment, the system 10 is adapted to allow a campaign creator to suggest the number of content pieces in Step 142, and send the suggestion to the online identities in Step 144. The online identities then submit to accept the offer and the price in Step 146. In one embodiment, the system 10 provides an interface as shown in FIG. 25 to specify the dialog scripts for approving and rejecting the submission of the online identities sent to the campaign creator in Step 146.

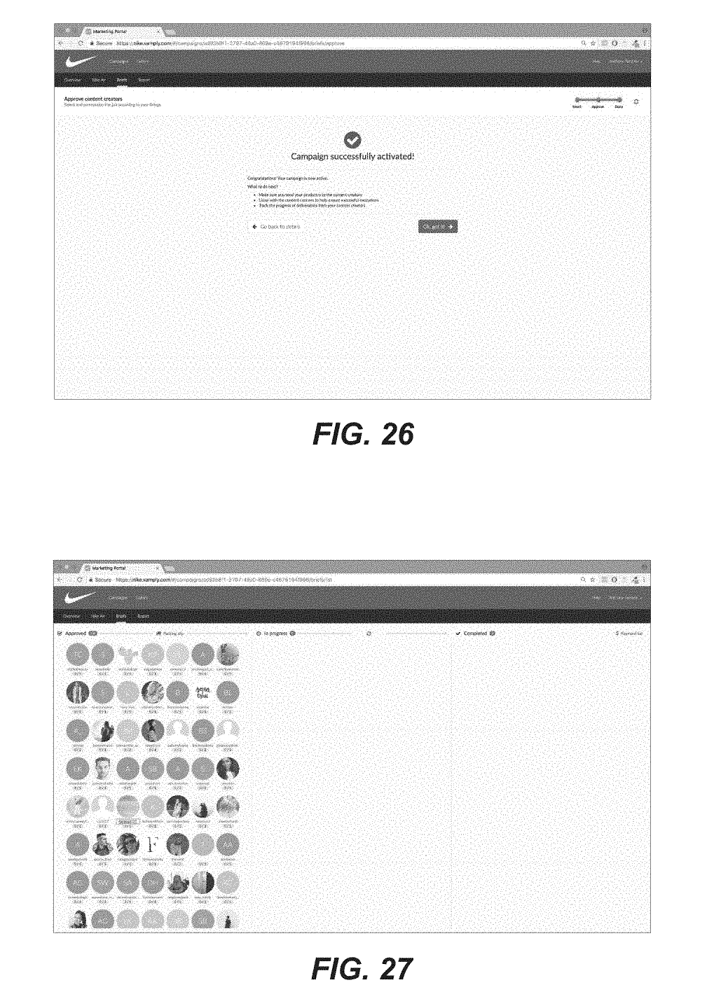

After the campaign creator has confirmed with all the list of online identities, the number of content pieces, and the prices, the campaign creator may then approve the campaign in Step 148. Once the campaign is approved, the system 10 will direct the user to a campaign approval interface as shown in FIG. 26.

Typically, the campaign creator will send out any physical products and/or brief packages for the online identities to create social media contents. For example, the campaign creator may send out shoes or dresses to the online identities to take photographs and/or video, and upload the photographs to INSTAGRAM® and the video to a YouTube® channel.

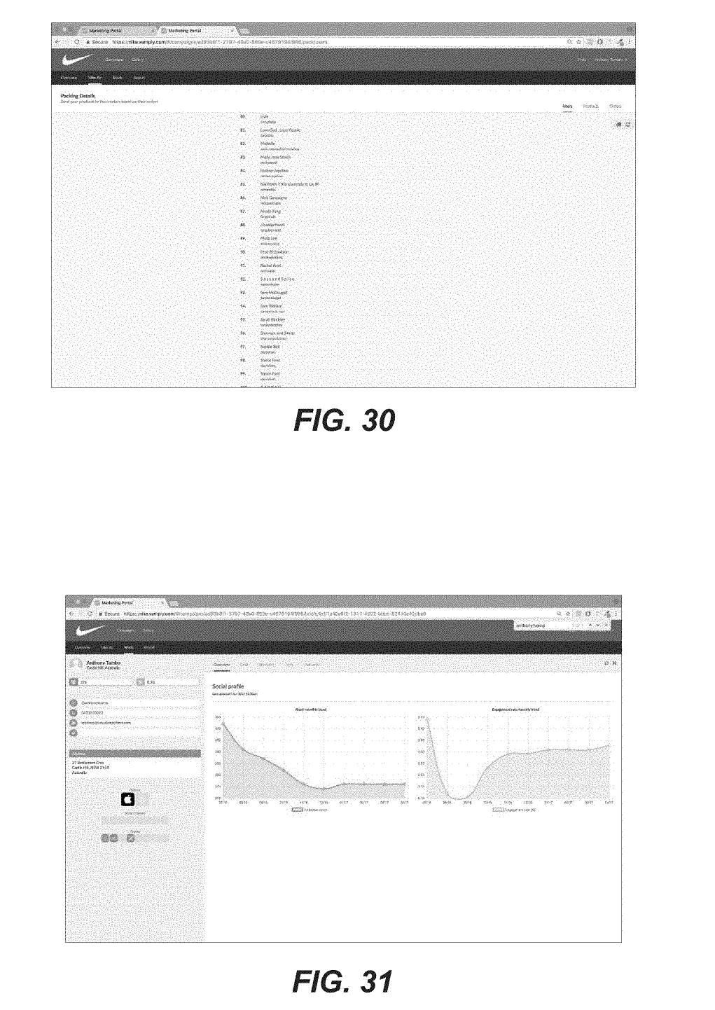

FIG. 27 shows a Campaign Tracking Interface of the system 10 of a preferred embodiment of the present invention to manage a campaign. On the left-hand section of the interface, there is provided a list of approved online identities or influencers. In one embodiment, the system 10 provides another Tracking Interface as shown in FIG. 30, showing a list of online identities to whom the campaign creator needs to send the products for creating social media contents.

The user may track whether the physical products and/or brief package has been sent out. In the middle section of the interface, the system 10 tracks the progress of the campaign, such as the number of social media contents posted on the social media websites. In the right-hand section of the interface, the system 10 tracks the campaign in the complete stage, such as payment to the online identities or influencer.

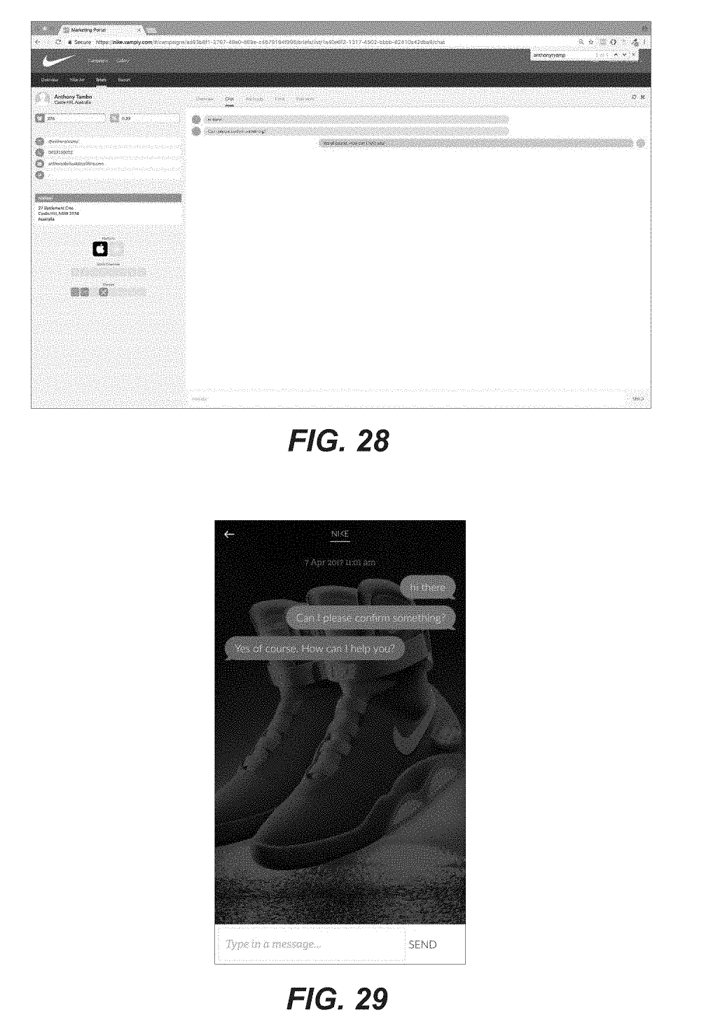

On the Campaign Tracking Interface as shown in FIG. 27, the online identities or influencers are presented with a profile photograph and a brief description of the online identity. When a user clicks on the profile photograph, the system 10 will direct the user to an Influencer Profile Interface as shown in FIG. 28.

On the Influencer Profile Interface of the system 10, the user may view the profile details of the online identity or influencer, such as the real name, location, online handle, contact number, email address, postal address, system platform, social media channel, themes, . . . etc.

In one embodiment, the system 10 also allows the user to view the overview information of the online identity from the Overview Interface as shown in FIG. 31. The Overview Interface displays statistical information of the online identity, such as “reach monthly trend” and the “engagement monthly trend.” In one embodiment, the system 10 may also collect and generate other social media measurement metrics, such as volume in actions, shares and views; reach; engagement; influence; shares, traffic driven; click-through with bounce rate; conversation rate; amplification rate; applause rate; and leads. In another embodiment, the Overview Interface allows the user to compare the social media measurement metrics among different online identities or influencers, with aggregate values of the entire campaign, or with historical values of a previous campaign.

In another embodiment, the system 10 may project the expected performance of a campaign by interpolating the historical and current social media measurements. The user may use this projection facility to simulate the performance of different groups of online identities or influencers when filtering and choosing the group of online identities to work on the campaign.

There is also provided a chatting facility for a user of system 10 to communicate with the online identity. The chatting facility allows users to communicate with the online identity across multiple platforms, such as mobile and tablet. FIG. 29 shows a screenshot of the chatting facility displayed on a smart phone.

In one of the preferred embodiment, the Influencer Profile Interface of system 10 allows the user to view, edit, change and delete the attributes of an online identity. On the Influencer Profile Interface, the user may also track the social media contents that are posted by the online identity or influencer for the campaign.

In one embodiment, the system 10 sends out a particular campaign handle for the online identity. When the online identity posts a piece of social media content, the online identity has to tag that piece of content with the campaign handle. The system 10 automatically tracks the online identity's social media page and searches for any contents that are tagged with the campaign handle. The system 10 then links to the piece of contents by “like,” “follow” and “share,” and reposts it under the Posts section of the Influencer Profile Interface.

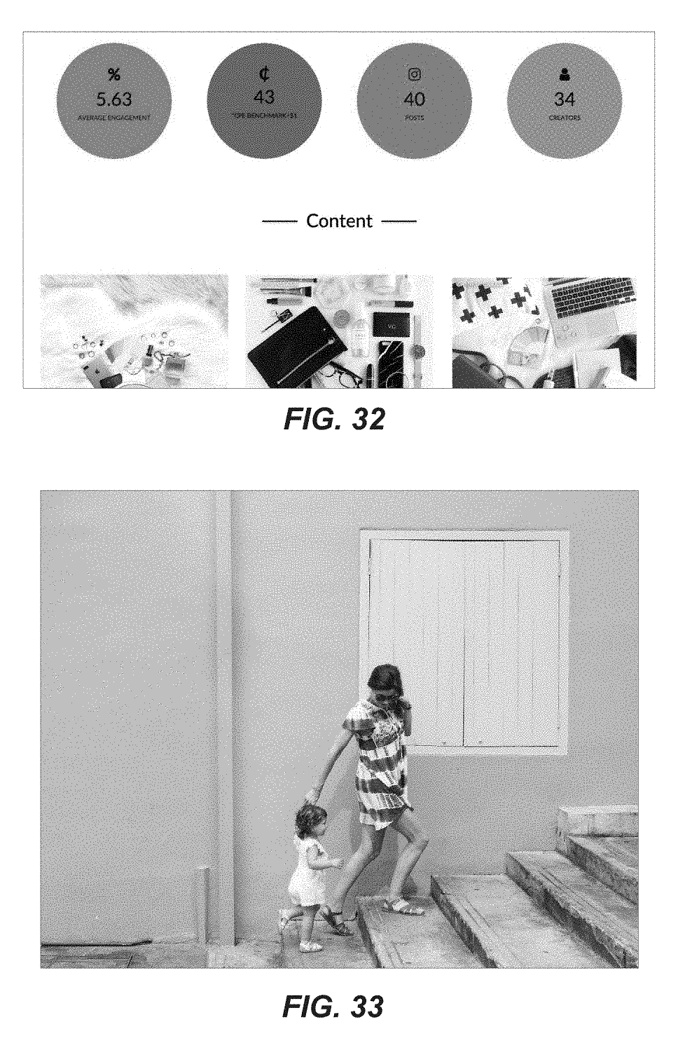

In one preferred embodiment, system 10 provides a General Report Interface as shown in FIG. 32 for a user to monitor the progress of the social media campaign. The General Report Interface shows a number of performance indicator of the campaign, such as the average engagement rate, CPE Benchmark, number of posts, number of creators, etc. Other performance indicators and statistical data may be shown in this General Report Interface as well. In another embodiment, the General Report Interface allows the user to customize the report. The General Reporting Interface may also display new social media contents recently posted for the campaign.

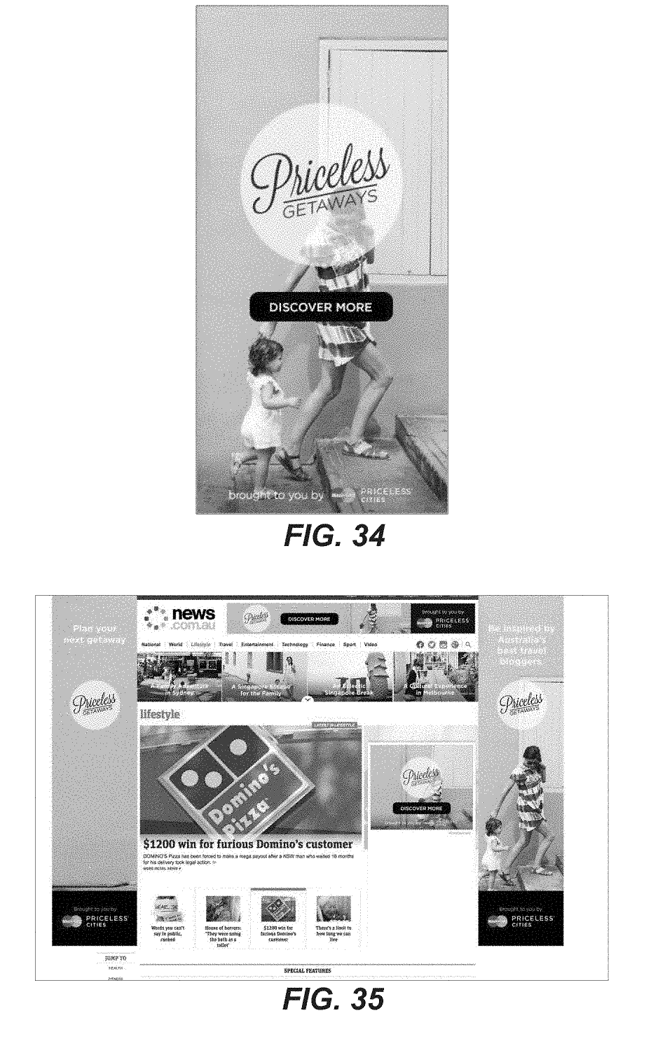

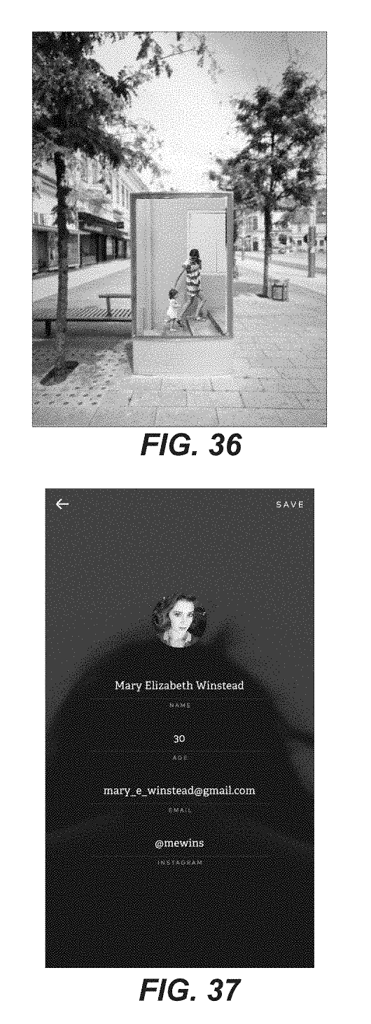

With the social media contents, the system 10 allows the user to share, or reuse them on different media such as INSTAGRAM® as shown in FIG. 33, a mobile app as shown in FIG. 34, web page banners as shown in FIG. 35, or even a poster on an advertising display as shown in FIG. 36, . . . etc. In another embodiment, the system 10 may automatically distribute, link, or share one or more retrieved social media contents on a webpage.

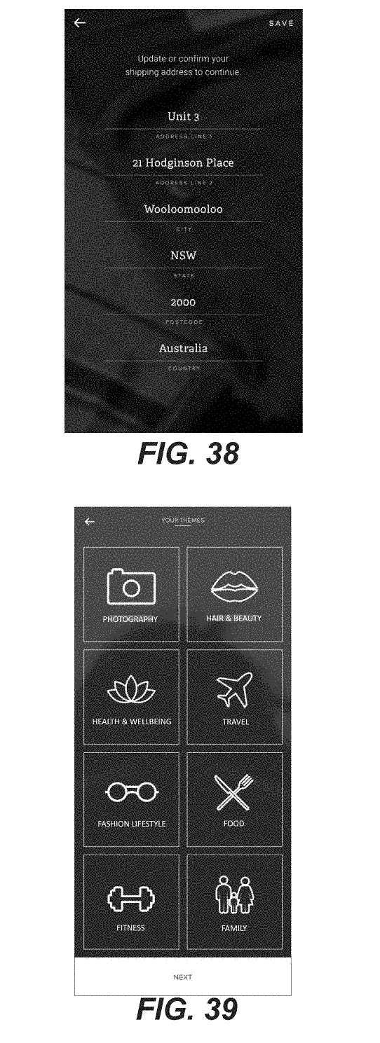

In a preferred embodiment of the present invention, system 10 allows an online identity or influencer to set up a profile using Profile Setup Interface. For example, the Profile Setup Interface allows the online identity to store the name, photograph, age, gender, and social media handle as shown in FIG. 37. Then, the online identity may input the shipping address as shown in FIG. 38. The online identity may also select the themes that he or she is interested in as shown in FIG. 39.

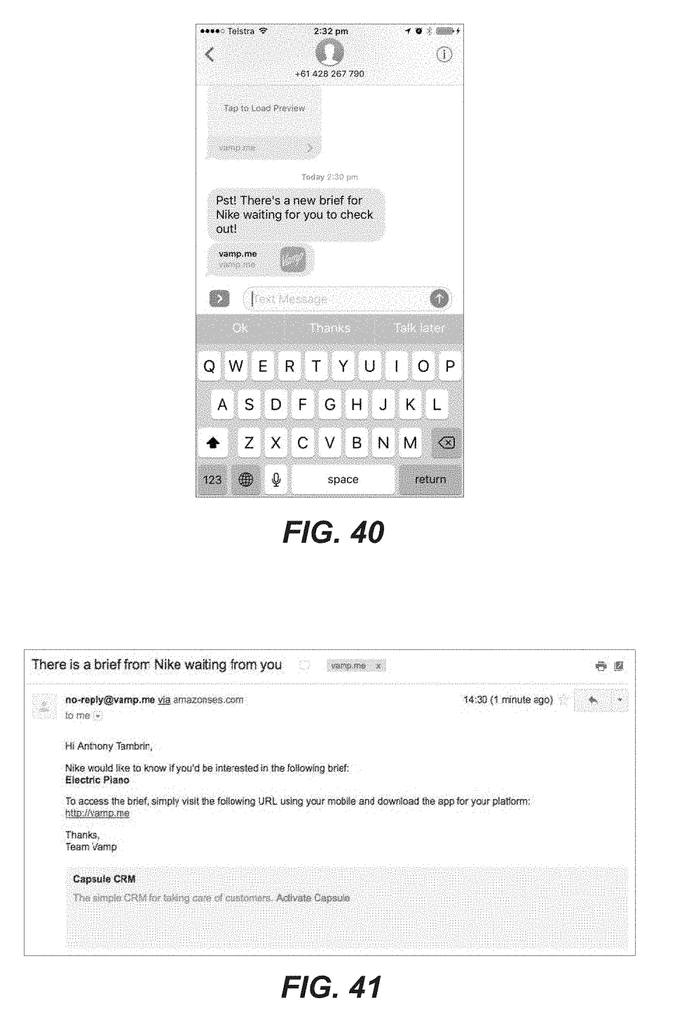

Reference now is made to the process for an online identity or influencer using the system 10 to accept and take part in a campaign. Once the campaign creator has created a campaign and selected a list of online identities to participate in a campaign, the system 10 will distribute invitations to the online identities or influencers. FIG. 40 shows an invitation to participate a campaign in the form of a SMS message received by an online identity. Similarly, FIG. 41 shows an invitation to participate a campaign in the form of an email message received by an online identity.

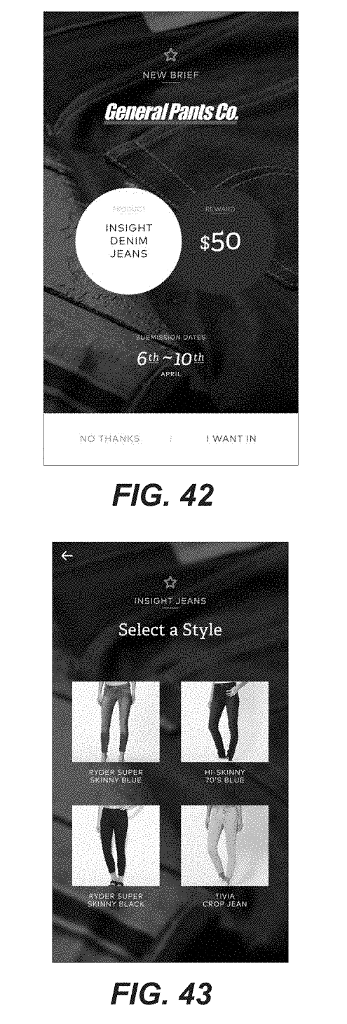

The system 10 provides an Opt-In Interface for the online identity to review the brief. For example, the Opt-In Interface as shown in FIG. 42 displays the name of the campaign, the product for creating the social media contents, the reward, and the campaign period, etc. On the Opt-In Interface, the online identity may accept the campaign task by clicking the “I WANT IN” icon, or decline the take by clicking the “NO THANKS” icon.

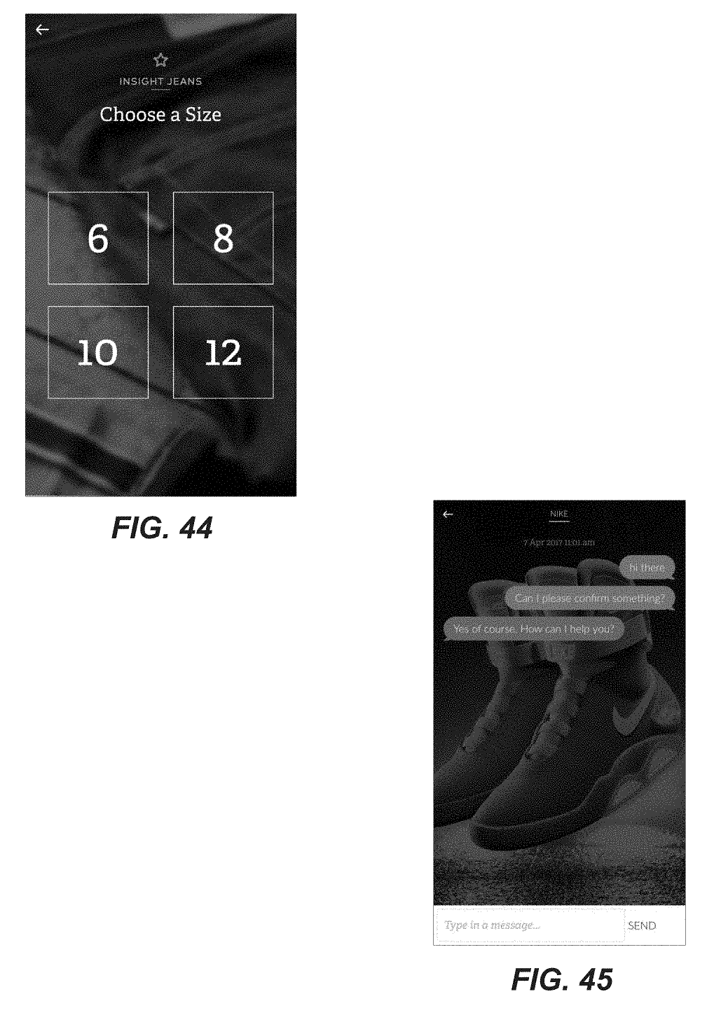

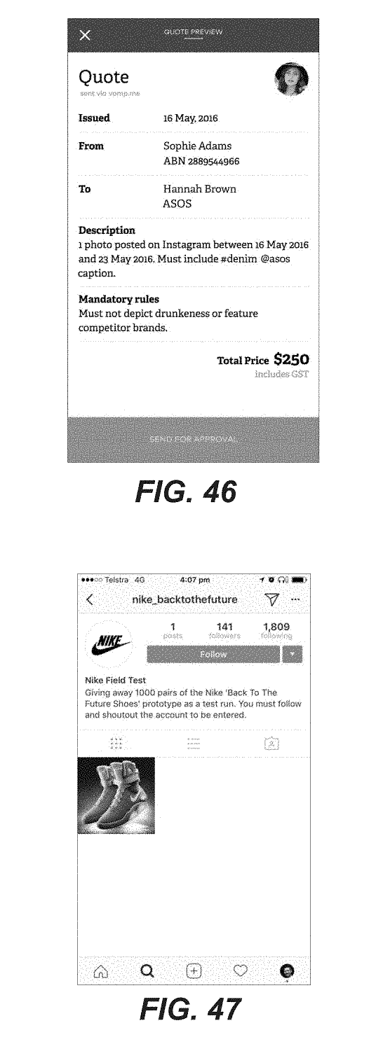

Once the online identity accepts the campaign task, the campaign creator can forward the brief package to the online identity. Sometimes, the brief package allows the online identity to acquire a new product to create the social media contents. In many cases, these new products may be exclusive to the online identity. In one embodiment, the system 10 provides an Ordering Interface for the online identity to order the new product as shown in FIGS. 43 and 44. In FIG. 43, there is provided an interface so the online identity may select a particular product to create social media contents. FIG. 44 shows an interface for the online identity to specify the particulars of the product, such as size, color, style, . . . etc. In this example, it is the AU/UK size of a piece of garment ranging 6-12 (or US size 2 to 8) can be specified in the Ordering Interface.

In one embodiment, the system 10 provides a Communication Interface for the online identity to communicate with the campaign creator. In one preferred embodiment of the present invention, the Communication Interface works on multiple platforms, such as email, SMS, mobile apps, etc. The system 10 is adapted to detect the platform it is running on and choose the applicable presentation to display the message. For example, the system 10 may detect when a mobile app is running and display the communication under the mobile app interface as shown in FIG. 45.

In another embodiment, the system 10 provides a Quote Preview Interface for the online identity to preview the quote and forward the quote to the campaign creator for approval. In the Quote Preview Interface, there is provided the issued date of the quote, the issuer of the quote, i.e., the real name of the online identity, the campaign creator, the description of the task, the mandatory rules, and the quote amount. When the campaign creator receives the quote, the campaign creator may accept or decline the quote.

Once the campaign creator accepted the quote, the online identity may then proceed to create and generate social media contents such as one shown in FIG. 47 on different social media websites including FACEBOOK®, FLICKR,® LINKEDIN®, YOUTUBE®, VEMO®, INSTAGRAM®, PINTEREST®, REDDIT®, BLOG®, TWITTER®, TWITCH®, TUMBLR®, WHATSAPP®, WECHAT®, AND SNAPCHAT®, etc.

With the social media contents, the system 10 allows the user to share, or reuse them on different media such as INSTAGRAM® as shown in FIG. 33, a mobile app as shown in FIG. 34, web page banners as shown in FIG. 35, or even a poster on an advertising display as shown in FIG. 36.

In another embodiment, the online identities or influencers can use the reporting function of the system 10 to monitor his/her performance, KPI, and the money earned from posting social media contents.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A social media contents proceeding method adapted to be executed on a computing device connected to the Internet, wherein the method comprising the steps of:
providing a user interface on the computing device for receiving one or more criteria, which comprises one or more of age, gender, theme, number of follows, engagement rate, related to a social market media campaign with a predefined online handle;
connecting to a database management system for compiling a set of online identities on social media websites matching the one or more criteria;
retrieving social media contents from one or more social media websites associated with the online handle and the set of online identities, and calculating a total amount of social media contents associated with each of the online identities with the online handle.

2. The method of claim 1, wherein the step of compiling a set of online identities further comprises the steps of adding one or more online identities to the set.

3. The method of claim 1, wherein the step of compiling a set of online identities further comprises the steps of removing one or more online identities from the set.

4. The method of claim 1, further comprising the steps of:
displaying one or more statistical presentations in accordance with the retrieved set of online identities;
receiving input from a user to adjust the statistical data on the statistical presentations; and
adding or removing one or more online identities such that the set of online identities satisfies the adjusted statistical data.

5. The method of claim 4, wherein the statistical data comprises a total budget for a project.

6. The method of claim 1, further comprising the step of sending an electronic invitation in one data format to each online identity in the set.

7. The method of claim 6, further comprising the steps of receiving a quote message sent from one or more online identities in the set.

8. The method of claim 7, further comprising the steps of compiling a final set of online identities, and forwarding a commission message to each of the online identities in the final set.

9. The method of claim 1, further comprising the steps of:
compiling a tracking report in accordance with the retrieved social media contents, wherein the tracking report comprises a list of each online identity and corresponding status in the marketing campaign.

10. The method of claim 9, wherein the tracking report comprises aggregate data comprising one or more of engagement rate, bounce rate, traffic driven, number of shares, track conversation rate, amplification, applause rate, or leads, in accordance with the retrieved social media contents.

11. The method of claim 1, further comprising the steps of:
accepting one or more orders from a user device of an online identity;
updating the status of the online identity.

12. The method of claim 1, further comprising the steps of determining a payment threshold status in accordance with the total amount of social media contents of an online identity.

13. The method of claim 12, further comprising the step of making an electronic payment to the online identity based on the payment threshold status through a transaction server.

14. The method of claim 1, further comprising the steps of automatically distributing, linking, or sharing one or more retrieved social media contents on a webpage.

15. A computer system, having a processing unit, data storage, and a communication module for connecting to the Internet, comprising:
a user interface adapted to receiving one or more criteria, that comprises one or more of age, gender, theme, number of follows, engagement rate, related to a social market media campaign with a predefined online handle to a computer server;
a database management system for compiling a set of online identities on social media websites matching the one or more criteria;
a data retriever adapted to retrieving social media contents from one or more social media websites associated with the online handle and the set of online identities,
wherein the processing unit is adapted to calculating a total amount of social media contents associated with each of the online identities with the online, handle.

16. The computer system of claim 15, wherein the processing unit is configured to determine payment threshold status in accordance with the total amount of social media contents of an online identity, and forward electronic payment instructions to a transaction server for transferring payment to the online identity.

17. The computer system of claim 15, wherein the processing unit automatically distributes, links, or shares one or more retrieved social media contents on a remote web server.

18. The computer system of claim 15, further comprising:
a statistical data display interface adapted to receiving input from a user to adjust statistical data on a statistical presentation in accordance with the retrieved set of online identities,
wherein the statistical data display interface is adapted to allow adding or removing one or more online identities such that the set of online identities satisfies the adjusted statistical data.

19. The computer system of claim 15, wherein the communication module is adapted to sending an electronic invitation in one data format to each of the online identities in the set, receiving a quote message or an order from an online identity.

20. The computer system of claim 16, wherein the computing device comprises:
a message editor for an online identity to compile a quote message in response to an invitation; and
an ordering interface for an online identity to select an item to order.
